(19) United States
(12) Patent Application Publication
(10) Pub. No.: US 2025/0247414 A1
(43) Pub. Date: Jul. 31, 2025

(54) SYSTEM AND METHOD FOR REAL TIME CYBERSECURITY COMPLIANCE

(71) Applicant: Saudi Arabian Oil Company, Dhahran (SA)

(72) Inventors: Mazen A. Baragaba, Dammam (SA); Jamal M. Abbad, Dammam (SA); Hani Jaser, Dammam (SA); Tariq O. Maghrabi, Dammam (SA)

(21) Appl. No.: 18/427,204

(22) Filed: Jan. 30, 2024

(51) Int. Cl. H04L 9/40

(52) U.S. Cl. CPC H04L 63/1433

(57) ABSTRACT

Methods, systems, and computer-readable storage media for receiving, from probes, probe data indicative of vulnerabilities of one or more devices to cybersecurity threats. The devices are connected over a network. Aggregated probe data is generated by mapping the probe data using data relationships obtained from a relational database, The data relationships define vulnerability types of cybersecurity threats. A cybersecurity compliance score of each of the one or more devices is determined using a correlation of the aggregated probe data to cybersecurity status scenarios defining consequences related to the cybersecurity threats. A cybersecurity assessment report including the compliance score of the one or more devices and an action plan preventing the consequences related to the cybersecurity threats are provided.

### TECHNICAL FIELD

The present disclosure generally relates to data security and more specifically to cybersecurity compliance assessment.

### BACKGROUND

Cybersecurity is generally implemented to provide protection for an organization's data or/and infrastructure from malicious entities intending to compromise the data, potentially affecting operations and services. The fluctuation of a number and severity level of attacks defines a cybersecurity state that is continuously monitored. The cybersecurity state is continuously monitored to quantify potential threats for identification and prevention. Threat prevention includes timely and efficiently responding to potential threats. Considering the continuous changes of threat characteristics and level, organizations continuously benchmark their cybersecurity state against international, national, and/or customized standards or frameworks to identify analyze their cybersecurity state relative to compliance with recommended practices.

### SUMMARY

Implementations of the present disclosure are directed to cybersecurity compliance assessment. More particularly, implementations of the present disclosure are directed to providing a real-time cybersecurity assessment compliance report including the cybersecurity status of multiple devices and machines.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

Implementations described in the present disclosure, provide an overall score of cybersecurity assessment compared to target cybersecurity configurations including predefined key performance indicators. The cybersecurity assessment illustrates results per domain, major strengths, and deficiencies areas. Configurations can be adjusted to reflect most current compliance requirements that are associated to highest security standards. An advantage of the described technology is that it provides key recommended actions for improving system security to ensure continuation of services and operations. Furthermore, the described cybersecurity assessment approach allows an analysis of blocked threat attempts that can be used for training machine learning models that are integrated in detection of prevention of threats. Another advantage of the described technology is that the described cybersecurity assessment allows users (e.g., cybersecurity managers) to optimize plans for prioritized cybersecurity roadmap projects and make informed decisions to achieve the desired cybersecurity compliance target level. The cybersecurity settings facilitate optimization of other aspects of machine and device operations for continuation of services and operations.

The details of one or more implementations of the subject matter of the specification are set forth in the accompanying drawings and the description below. Other features, aspects, and advantages of the subject matter can become apparent from the description, the drawings, and the claims.

### DESCRIPTION OF THE DRAWINGS

The accompanying drawings, which are incorporated in and constitute a part of this specification, show particular aspects of the subject matter disclosed herein and, together with the description, help explain some of the principles associated with the disclosed implementations. In the drawings,

FIG. 1A is a block diagram of an example system that can be used to execute implementations of the present disclosure;

FIG. 1B is a block diagram of a portion of the example system that can be used to execute implementations of the present disclosure;

FIG. 2 depicts a flowchart illustrating an example process for cybersecurity compliance assessment, in accordance with some example embodiments;

FIG. 3 depicts a block diagram illustrating a computing system, in accordance with some example embodiments; and

FIG. 4 illustrates hydrocarbon production operations, in accordance with some example embodiments.

When practical, like labels are used to refer to same or similar items in the drawings.

### DETAILED DESCRIPTION

Implementations of the present disclosure are directed to cybersecurity compliance assessment. More particularly, implementations of the present disclosure are directed to cybersecurity assessment of industrial plants and/or computing systems. The described implementations provide a quantification of cybersecurity attributes of industrial machines and computing systems of an industrial plant, according to cybersecurity standards, frameworks, critical controls, and privacy demands for each component of the industrial plant and/or computing systems. Probes can be attached to or integrated in the industrial machines and computing systems to generate probe data indicative of the cybersecurity of the respective components of the industrial plant. The probe data is aggregated according to an aggregation schema to generate aggregated probe data. The aggregated probe data can be processed based on different cybersecurity status scenarios to obtain a cybersecurity status of each of the components of the industrial plant. Since cybersecurity status scenarios are defined according to several different cybersecurity standards, frameworks, critical controls, and privacy demands, a cybersecurity assessment report can include the cybersecurity status per scenario, to determine which correction operations to be initiated as a remedy to actively minimize the cybersecurity threats and comply with the required cybersecurity policy and mandate.

Addressing the challenges of evolving industrial plant security threats, the cybersecurity compliance assessment and security control protocol described in the present disclosure enable adjustment of cybersecurity configurations according to multiple cybersecurity standard levels and security demands for industrial plant and their respective industrial plant including industrial machines and computing systems. A subset of the industrial plant components can be defined as being relevant for a particular cybersecurity scenario. Individual industrial plant components have different cybersecurity risk levels, which are considered in determining an overall cybersecurity score. The cybersecurity score of the industrial plant is compared to a reference score corresponding to pre-defined cybersecurity defaults for regional (national, federal, and international) cybersecurity regulation to identify action plans to improve the cybersecurity of the industrial plant. Same approach can be implemented in any system including multiple computing devices.

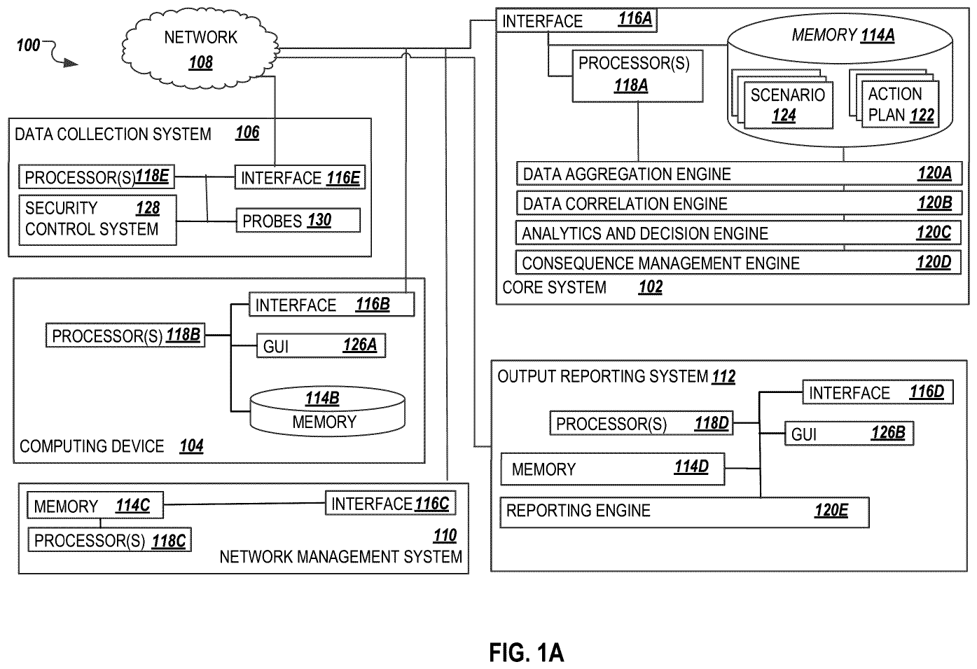

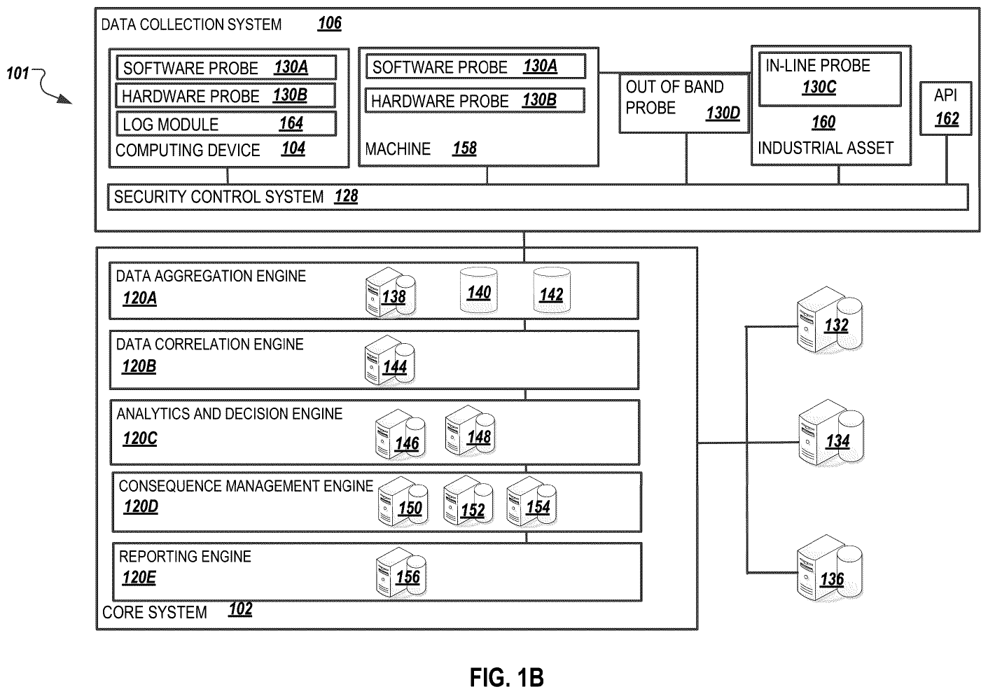

An advantage of the implementations described in the present disclosure is that they provide an overall score of cybersecurity assessment compared to target cybersecurity configurations including predefined key performance indicators. The cybersecurity assessment illustrates results per domain, major strengths, and deficiencies areas. Configurations can be adjusted to reflect most current compliance requirements that are associated to highest security standards. Another advantage of the described technology is that it provides key recommended actions for improving system security to ensure continuation of services and operations. Furthermore, the described cybersecurity assessment approach allows an analysis of blocked threat attempts that can be used for training machine learning models that are integrated in cybersecurity assessment. Another advantage of the described technology is that the described cybersecurity assessment allows users (e.g., cybersecurity managers) to optimize cybersecurity settings or to optimize other aspects of machine and device operations for continuation of services and operations. The cybersecurity status reflecting a threat level can also be correlated to a disruption level of industrial plant operations and services with respect to particular threats (fully prevented or partly prevented). The correlation of threat prevention to continuity of industrial plant operations and services provides cybersecurity transparency, which can be used for optimizing future cybersecurity measures by adjusting cybersecurity scenarios used by machine learning models to determine cybersecurity status. Fine tuning of machine learning models can maximize the threat prevention. Moreover, collaboratively training the machine learning models can promote optimal threat prevention performance in view of evolving threats. Other advantages of the cybersecurity assessment techniques are described with reference to FIGS. 1A, 1B, 2, and 3.

FIG. 1A is a block diagram illustrating an example system 100 for cybersecurity assessment of industrial plants. Specifically, the illustrated example system 100 includes or is communicably coupled with a core system 102, a computing device 104, a data collection system 106, a network 108, a network management system 110, and an output reporting system 112. Although shown separately, in some implementations, functionality of two or more systems or components of the example system 100 may be provided by a single system or server. In some implementations, the functionality of one illustrated system, server, or component may be provided by multiple systems, servers, or components, respectively.

In the example of FIG. 1A, the core system 102 is intended to represent various forms of servers including, but not limited to a web server, an application server, a proxy server, a network server, and/or a server pool. In general, the core system 102 manages cybersecurity assessment of industrial plants and coordinates threat prevention operations for any number of components of the example system 100 including computing devices 104 (e.g., over the network 108). In accordance with implementations of the present disclosure, and as noted above, the core system 102 can host a solution environment that can be a cloud environment providing software applications, systems, and services that can be consumed by customers as a service. In some instances, the core system 102 can support configuring of various tenants of different types, as well as services of different types that are integrated in customer integration scenarios and support execution of defined processes.

For example, the core system 102 includes a memory 114A, an interface 116A, a processor 118A, a data aggregation engine 120A, a data correlation engine 120B, an analytics and decision engine 120C, and a consequence management engine 120D. The memory 114A can include scenarios 124 and action plans 122. The scenarios 124 define consequences of cybersecurity threats and provide references to external regulation compliance resources. in some implementations, the scenarios 124 can be accessible or stored by the data collection system 106. The scenarios 124 can be analyzed based on cybersecurity configurations, by the data correlation engine 120B and the analytics and decision engine 120C. In some implementations, a cybersecurity dependency defined by the scenarios 124 can also point to internal security regulations set within the example system 100 (e.g., regulations adjusted to reflect the vulnerabilities of the components the example system 100). The action plans 122 in the memory 114A can include action plan documents defining threat prevention mechanisms including operations that can be performed by the components the example system 100 to annihilate detected threats. The data aggregation engine 120A can aggregate information received from the data collection system 106 to generate aggregated data. The data correlation engine 120B can correlate aggregated data, received from the data aggregation engine 120A, using machine learning models and scenarios 126, to generate correlated data. The analytics and decision engine 120C can process correlated data, received from the data correlation engine 120B, using machine learning models to generate cybersecurity assessments that are sent to the consequence management engine 120D that takes decisions based on the action plans 122.

The computing device 104, the network management system 110, and the output reporting system 112 may each be any computing device operable to connect to or communicate in the network(s) 108 using a wireline or wireless connection. In general, each of the computing device 104, the network management system 110, and the output reporting system 112 includes an electronic computer device operable to receive, transmit, process, and store any appropriate data associated with the example system 100 of FIG. 1. Each of the computing device 104, the network management system 110, and the output reporting system 112 is generally intended to encompass any client computing device such as a laptop/notebook computer, wireless data port, smart phone, personal data assistant (PDA), tablet computing device, one or more processors within these devices, or any other suitable processing device. The computing device 104, the network management system 110, and the output reporting system 112, respectively include interface(s) 116B, 116C, 116D, processor(s) 118B, 118C, 118D, and memories 114B, 114C, 114D.

The computing device 104 and the output reporting system 112, respectively include graphical user interface(s) (GUIs) 126A and 126B. For example, the GUIs 126A, 126B include an input device, such as a keypad, touch screen, or other device that can accept user information, and an output device that conveys information associated with the operation of the core system 102, or the client device itself, including cybersecurity assessment data (reports), and/or threat prevention operations, respectively. The GUIs 126A, 126B each interface with at least a portion of the example system 100 for any suitable purpose, including generating a visual representation of the data collected by the data collection system 106, data generate by the core system 102, or data stored by the core system 102, such as scenarios 124 and action plans 122, respectively. In particular, the GUIs 126A, 126B may each be used to view and adjust various cybersecurity configurations. Generally, the GUIs 126A, 126B each provide the user with an efficient and user-friendly presentation of cybersecurity data provided by or communicated within the example system 100. The GUIs 126A, 126B may each include multiple customizable frames or views having interactive fields, pull-down lists, and buttons operated by the user. The GUIs 126A, 126B can each be any suitable graphical user interface, such as a combination of a generic web browser, intelligent engine, and command line interface (CLI) that processes information and efficiently presents the results to the user visually.

The output reporting system 112 can include a business intelligent (BI) module, the GUI 126B (dashboard), a user module, and administrator modules. The BI model utilizes the analytics data provided by the consequence management engine 120D to produce executive and semi executive level displays for the GUI 126B. The GUI 126B displays a high-level summary of the cybersecurity assessment which provides the overall score of the assessment compared to the target predefined key performance indicators, per domain, major strength and deficiencies areas in addition to key recommended actions for improvements. The GUI 126B display can enable enterprise management and decision makers to modify (operations of) the industrial plant. Additionally, the BI module provides an analyst level customized dashboard with a drill down capabilities to provide more detailed analysis for different working groups.

The data collection system 106 can include a security control system 128 and multiple probes 130. The security control system 128 controls operation of the probes 130 and directs collected data to the core system 102 for storage, further analysis and correlations. The probes 130 can monitor multiple type of components (computing systems, industrial machines, and industrial assets) of the example system 100. The probes 130 can be coupled to or integrated in different types of components of the example system 100, to continuously monitor and secure the cybersecurity of the example system 100. Further details about the probes 130 and their operation are provided with reference to FIG. 1B.

In some implementations, the network 108 can include a large computer network, such as a local area network, a wide area network, the Internet, a cellular network, a telephone network or an appropriate combination thereof connecting any number of communication devices, mobile computing devices, fixed computing devices and server systems. Data exchanged over the network 108, is transferred using any number of network layer protocols, such as Internet Protocol, Multiprotocol Label Switching, Asynchronous Transfer Mode, Frame Relay, etc. Furthermore, in implementations where the network 108 represents a combination of multiple sub-networks, different network layer protocols are used at each of the underlying sub-networks. In some implementations, the network 108 represents one or more interconnected internetworks, such as the public Internet.

Each processor 118A, 118B, 118C, 118D, 118E included in different components of the example system 100 can include a central processing unit, an application specific integrated circuit, a field-programmable gate array, or another suitable component. Generally, each processor 118A, 118B, 118C, 118D, 118E executes instructions and manipulates data to perform cybersecurity operations. Specifically, each processor 118A, 118B, 118C, 118D, 118E executes a functionality required to monitor cybersecurity of the example system 100, to adjust cybersecurity configurations, and to execute operations to prevent threats.

Interfaces 116A, 116B, 116C, 116D, 116E are used by different components of the example system 100 for communicating with other component systems in a distributed environment—including within the example system 100—connected to the network 108. Generally, the interfaces 116A, 116B, 116C, 116D, 116E each include logic encoded in software and/or hardware in a suitable combination and operable to communicate with the network 108. More specifically, the interfaces 116A, 116B, 116C, 116D, 116E may each include software supporting one or more communication protocols associated with communications such that the network 108 or interface's hardware is operable to communicate physical signals within and outside of the illustrated system 100.

The memory 1114A, 114B, 114C, 114D may include any type of memory or database module and may take the form of volatile and/or non-volatile memory including, without limitation, magnetic media, optical media, random access memory, read-only memory, removable media, or any other suitable local or remote memory component. The memory 1114A, 114B, 114C, 114D may store various objects or data, including caches, classes, frameworks, applications, backup data, business objects, jobs, web pages, web page templates, database tables, database queries, repositories storing cybersecurity data and/or dynamic information, and any other appropriate information including any parameters, variables, algorithms, instructions, rules, constraints, or references thereto associated with the purposes of the core system 102, the computing device 104, the data collection system 106, the network management system 110, and the output reporting system 112, respectively.

There may be any number of computing devices 104 and data collection systems 106 associated with, or external to, the example system 100. Additionally, there may also be one or more additional client devices external to the illustrated portion of system 100 that are configured for interacting with the example system 100 via the network(s) 108. Further, the term “client,” “client device,” and “user” may be used interchangeably as appropriate without departing from the scope of the disclosure. Moreover, while client device may be described in terms of being used by a single user, the disclosure contemplates that many users may use one computer, or that one user may use multiple computers. As used in the present disclosure, the term “computer” is intended to encompass any suitable processing device. For example, although FIG. 1A illustrates a single core system 102, a single computing device 104, a single data collection system 106, a single network management system 110, the example system 100 can be implemented using a single, stand-alone computing device, two or more core systems 102, or multiple client devices. The core system 102, the computing device 104 and the output reporting system 112 may include any computer or processing device such as, for example, a blade server, general-purpose personal computer, workstation, or any other suitable device. In other words, the present disclosure contemplates computers other than general purpose computers, as well as computers without conventional operating systems. Further, the core system 102 and the computing device 104 and the output reporting system 112 may be adapted to execute any operating system or runtime environment. According to one implementation, the core system 102 may also include or be communicably coupled with an e-mail server, a Web server, a caching server, a streaming data server, and/or another suitable server, as described with reference to FIG. 1B.

To further illustrate, FIG. 1B depicts a schematic diagram illustrating an example portion 101 of a variation of the example system 100 described with reference to FIG. 1A, in accordance with some example embodiments. The example portion 101 of the example system 100 illustrated in FIG. 1B includes the core system 102, the data collection system 106, and multiple other external systems, such as a cyber intelligence module 132, an asset management and classification module 134, and a policy and standards database 136. The cyber intelligence module 132 collects intelligence data and makes it available for the data aggregation engine 120A for storage. The intelligence data is used to validate compliance status generated by the data collection system 104. The intelligence data is also used by the analytics and decision engine 120C to make further decisions and to confirm the compliance status. The input from a database of the asset management and classification module 134 can be used as input for the core system 102 to make informed decisions on the compliance status for all assets and corresponding owners. The policy and standards database 136 includes mandatory controls that the core system 102 uses to check for compliance. For example, the policy and standards database 136 can store a master list of control requirements that can be assessed for compliance.

The core system 102 includes the data aggregation engine 120A, the data correlation engine 120B, the analytics and decision engine 120C, the consequence management engine 120D, and the reporting engine 120E. The data aggregation engine 120A includes and aggregation module 138, a relational database 140, and a real time database 142. The aggregation module 138 aggregates data received from the data collection system 106 using data relationships obtained from the relational database 140. The aggregated data can be transmitted by the aggregation module 138 to the real time database 142 for storage and further processing.

The data correlation engine 120B includes a correlation module 144. The correlation module 144 correlates data received from hardware, software, inline and out of band probes, in addition to data obtained from various infrastructure devices, such as multiple other external systems, such as the cyber intelligence module 132, the asset management and classification module 134, and the policy and standards database 136.

The analytics and decision engine 120C includes an analytics module 146 and a decision module 148. The analytics and decision engine 120C uses the analytics module 146 and the decision module 148 to determine whether encryption was applied or not to the aggregated data and which application traffic is not encrypted. The analytics module 146 conducts deep analytics and assessments of the data received from the data correlation engine 120B and feeds the results of the analytics and assessments to the decision module 148. The decision module 148 delivers real-time preemptive decisions associated with no errors about compliance status against cybersecurity policies and standards.

The consequence management engine 120D includes an alert agent module 150, a consequence module 152, and an escalation module 154. The alert agent module 150 provides (immediate) alerts to the organizations to provide an action plan before a set time limit ends. If the action plan is not received before the set time limit, the escalation module 154 escalates the finding to a higher level. If the action plan is received, the alert agent module 150 provides alerts to the organizations to trigger (automatic or semi-automatic) implementation of the action plan. If the action plan implementation is not completed before a set time, the escalation module 154 escalates the implementation of the action plan, for example by triggering a backup set of automatic operations to ensure security of the industrial plant.

The reporting engine 120E includes a reporting module 156. The reporting module 156 collects the analyzed data and related decisions from the analytics and decision engine 120C. The output of the analytics and decision engine 120C can be processed by the reporting module 156. The reports include the cybersecurity assessment results relative to governance, risk, and compliance (GRC) policies and standards of the applicable organizations obtained from the policy and standards database 136. The reports indicate the cybersecurity assessment results at an appropriate level, depending on the assets and the data classification, providing an action plan within a provided time limit.

The data collection system 106 includes probes 130A, 130B, 130C, 130D coupled to different components including the computing device 104, a machine 158, and an industrial asset 160. The probes 130A, 130B, 130C, 130D are communicatively connected to a security control system 128. The probes 130A, 130B, 130C, 130D include hardware probes, software probes, inline probes and out of band probes, in addition to data obtained from various infrastructure devices. The probes 130A, 130B, 130C, 130D collect evidence of security controls implementation from network, computing, security infrastructure devices as well as endpoints and network management systems.

The software probes 130A are installed on the computing device 104 to check the security controls and configuration baselines for network data, data indicative of processes and operations of computing devices and security devices such as firewalls, routers and switches, intrusion prevention systems, servers, and workstations. The software probes 130A compare collected data to predefined policies, controls, and baseline to identify compliance issues. The software probes 130A send the collected data to the analytics and decision engine 120C for further analysis and correlations.

The packet level inline hardware probes 130B collect data indicative of control implementations directly from the network traffic flows. The hardware probes 130B are devices that analyze internet protocol packets, list, and categorize the inbound and outbound running applications and check for the security metrics, such as clear text password, data classification, encryption, list of systems and vulnerability as required by the mandated compliance controls. The hardware probes 130B (can be enabled or disabled as required) to analyze the traffic traversing the device and to determine if the security controls or any other mandatory requirements is in place (compliant or not) to determine the compliance status (yes, no, or partial) for specific security controls compared to a pre-determined set of standards. The compliance status can be helpful for multiple scenarios. For example, the compliance status can be helpful for limited and ad-hoc consultancy engagement, where deploying the full system components are costly and not feasible. As another example, the compliance status can be helpful for small or medium size organizations that measure cybersecurity implementation level of a specific standards or critical controls. The hardware probes 130B send the collected data to the analytics and decision engine 120C for further analysis and correlations.

The log module 164 collects logs from infrastructure devices, end points, network infrastructure logs, security information and event management system, security systems logs and management system logs in addition to other logs that are sent to the central log management system. The log module 164 sends the collected logs to the data aggregation engine 120A for storage and for data correlation.

The example system 100 uses an application programming interface (API) 162 to detect workloads such as virtual machines, databases, storage, keystores, and load balancers of the industrial plant. In some embodiments, workloads may exist as virtual machines, while in other embodiments, workloads may exist as discrete, physical devices (e.g., computing devices and/or industrial machines). For example, in some embodiments, a layer routing system can be implemented as a physical device (e.g., a router or switch) or a virtual device (e.g., a routing system instantiated as a virtual device on a computer). Scanning components of the example system 100 may query devices and systems capable of routing and filtering traffic (e.g., load balancer, routers, switches, firewalls, security groups, API gateways and proxies) using the API module 162 (e.g., provided through a cloud service provider's system) to determine network configurations, and can evaluate the determined network configurations against known problematic configurations or other configurations. The API module 162 can also be integrated within software modules executed by components of the example system 100, to collect input data within the data collection system 106 and to transmit the collected data to the core system 102 (e.g., to the data aggregation engine 120A) for analysis and further decision.

While portions of the example system 100 illustrated in FIGS. 1A and 1B are shown as individual modules that implement the various features and functionality through various objects, methods, or other processes, the hardware components can execute software that can include multiple sub-modules, third-party services, components, libraries, and such, as appropriate. Conversely, the features and functionality of various components can be combined into single components as appropriate.

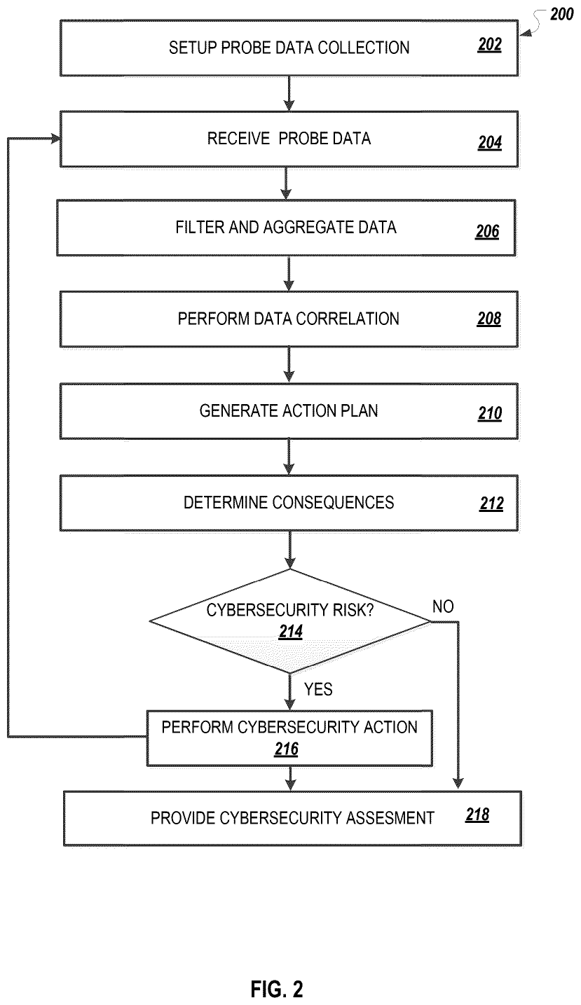

FIG. 2 depicts a flowchart illustrating an example process 200 for cybersecurity compliance assessment, in accordance with some example embodiments. Referring to FIGS. 1A and 1B, the process 200 can be performed by any components of the example system 100.

At 202, collection of data using multiple probes is configured, by one or more processors configured to manage probe data collection. The probes can include software probes and hardware probes as described with reference to FIGS. 1A and 1B. Each of the probes can be configured to collect data according to a particular schedule defining a frequency of data collection and a duration of each collection duration. The probes can be configured to collect data continuously (according to the respective schedule) or can have a set trigger that initiates data collection in response to detection of one or more conditions for data collection. The conditions can be defined based on legal regulations, law, and industrial plant operational conditions regarding an operational status (e.g., fully operational, partly operational, or minimally operational) one or more components of the industrial plant (e.g., example system 100 described with reference to FIGS. 1A and 1B). In some implementations, a list of security standards and controls are processed to initiate a real time cybersecurity compliance assessment identifying the target system components and coupled probes to be activated for collecting probe data. For example, if an approved document is requested as evidence for implementation of a security requirement, such as a particular cybersecurity strategy, a software probe can be initiated to monitor a document repository by inspecting metadata of the stored documents. The software probe can autonomously extract cybersecurity data by inspecting metadata of the stored documents and transmit the data to the processors, as probe data.

At 204, the probe data is received, by the one or more processors of a core system configured to process the probe data. The received probe data can be prefiltered by the probes that generated the probe data. For example, for conserving system resources by minimizing network traffic, the probe data can transmit only anomalous data potentially indicative of a cybersecurity threat or operational threat. The anomalous data can be identified as data outliers and/or data having one or more characteristics (frequency and/or amplitude) outside of an expected range. For example, the probes can include a high pass filter or a low pass filter to separate the anomalous data from normal operational data.

At 206, the probe data is filtered and aggregated, by the one or more processors of the core system configured to process the probe data. Probe data filtering can include applying complex filters based on system or machine operational patterns to the probe data to generate filtered probe data. Aggregation of the filtered probe data can include mapping of filtered probe data using data relationships obtained from a relational database defining vulnerability types. The aggregated data includes a compilation from similar data sets and aggregation of common threats to data structures likely to experience similar vulnerabilities. The aggregation of filtered probe data can be contained within a data structure, and it can be collectively aggregated to provide a robust and layered cybersecurity evaluation.

At 208, the aggregated data is correlated, by the one or more processors of the core system, to determine cybersecurity vulnerabilities. The aggregated data received from hardware, software, inline and out of band probes can be correlated using various cybersecurity classification standards and policies obtained from one or more databases. Data correlation can include analyzing the aggregated data to determine a cybersecurity compliance score. In some implementations, the data correlation include correlating each of the identified plurality of cybersecurity vulnerabilities with one or more system components (e.g., software, hardware, machines, and/or assets). The correlation can identify a connection between a security risk and a system component or a group of system components that can be simultaneously exposed to a cybersecurity threat. The identified connection or correlation of vulnerability to asset facilitates complementation of an action plan to address the vulnerability. The correlation of the aggregated data can be performed using a machine learning model configured to identify a connection between a security risk and a system component. The machine learning model can include a machine learning model pre-trained and fine-tuned to identify the connection between security risks and system components by interpreting patterns of the aggregated data within the context of different cybersecurity threats as defined by cybersecurity scenarios obtained from a database.

At 210, an action plan is generated, by the one or more processors of the core system, to correct the determined cybersecurity vulnerabilities. The cybersecurity compliance score of the determined cybersecurity vulnerabilities can be compared to a reference score of the respective cybersecurity vulnerability type. The difference between scores can be quantified to identify the gaps indicative of compliance targets. The cybersecurity gap can be corrected using recommended remediation actions to increase the level of compliance to reach a target cybersecurity level. The action plan can be identified by machine learning models (e.g., recurrent neural networks with a multi-layer network topology) trained and fine-tuned to generate a set of remedial actions to correct cybersecurity gaps. The system can determine scores for each system component to be validated based on a difference between each predicted value and the target cybersecurity level for the respective component, and the accuracy for the machine learning model that generated the predicted value. The trained machine learning models can be configured to operate in active mode, within the core system, facilitating automatic action plan implementation. For example, the trained machine learning models can trigger a modification of system component operations for blocking digital resources classified as malicious or communication channels identified as being vulnerable. In some embodiments, more than one trained machine model may be placed in active mode concurrently (that is, overlapping in a time), for example, those having an accuracy rate above a threshold or error rate below a threshold, or the like, during training, and their results for each suspicious digital resource analyzed during production statistically combined (e.g., probability values averaged) to yield the classification of the suspicious digital resource. In some implementations, the trained machine learning models can be configured to operate in non-blocking or inactive mode. In such a case, the trained machine learning model operates out-of-band on copies of content and the identified action plan does not result in the blocking of the content.

The action plan includes an automatic selection of remedial actions that can be triggered to be automatically performed based on system configurations. Remedial actions include, among other things, notification to an end user of an identified threat, compensation through a revised security code to mitigate the potential threat, publication of the identified threat and vulnerability in a log or record of detected vulnerabilities, and communication of the sensed vulnerability and threat to a server operator or maintainer to fortify the protections of workloads existing on similar environments. In some implementations, the remedial actions can be adjusted relative to a phase of a component's lifecycle. For example, new versions of software modules can be provided with changed terms and conditions. Additionally, the communication of a hardware component can be modified to minimize risks to malicious interference exposure associated to vulnerable communication channels. The action plan can be adjusted to new risk factors and system configurations. A summary of the action plan can be provided for display, to a graphical user interface. The performance of the action plan can be scheduled within a time limit.

At 212, in response to determining that the action plan failed to be performed and failed to be successfully completed before the set time deadline, consequences associated to the failed action plan are determined, by the one or more processors of the core system. The consequences include an automatic implementation of a remedial action of the action plan or a security operation to protect the system from a potential cybersecurity threat.

At 214, in response to determining that the remediation action plan was implemented, or the consequence derived back-up plan was applied, the cybersecurity risk is re-evaluated by comparing the updated cybersecurity score to the reference cybersecurity score. If the updated cybersecurity score is below the reference cybersecurity score, at 216, a cybersecurity action is performed by activating the probes to collect additional data. The comparison can indicate a success level of the remediation action plan and can be used for further training the machine learning models. If the updated cybersecurity score is greater than or equal to the reference cybersecurity score, at 218, a cybersecurity assessment report is provided for display, to the graphical user interface. The cybersecurity assessment report can be provided as a full or as a partially customized assessment. For example, the graphical user interface provides customizable features used for configuring the assessment reporting results and recommendations.

The example process 200 allows remotely configuring probes for collection of cybersecurity data including a broad spectrum of information by gathering probe data from different types of probes. The security assessment can be scheduled and automated, being initiated with probe data collection. The example process 200 provides accurate and consistent assessment results, by applying quantifiable measures of cybersecurity and comparisons to (national and international) standards.

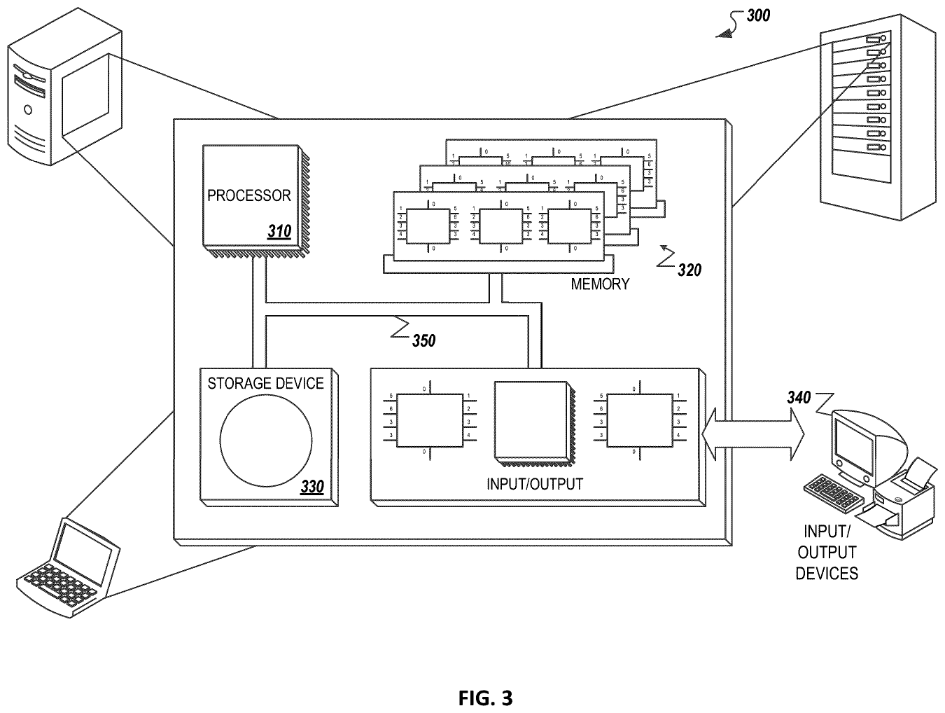

FIG. 3 depicts a block diagram illustrating a computing system 300, in accordance with some example embodiments. Referring to FIGS. 1A and 1B, the computing system 300 can be used to implement the core system 102 and/or any other components of the example system 100.

As shown in FIG. 3, the computing system 300 can include a processor 310, a memory 320, a storage device 330, and input/output devices 340. The processor 310, the memory 320, the storage device 330, and the input/output devices 340 can be interconnected using a system bus 350. The processor 310 is capable of processing instructions for execution within the computing system 300. Such executed instructions can implement one or more components of, for example, the example system 100. In some implementations of the current subject matter, the processor 310 can be a single-threaded processor. Alternately, the processor 310 can be a multi-threaded processor. The processor 310 is capable of processing instructions stored in the memory 320 and/or on the storage device 330 to display graphical information for a user interface provided using the input/output device 340.

The memory 320 is a computer readable medium such as volatile or non-volatile that stores information within the computing system 300. The memory 320 can store data structures representing configuration object databases, for example. The storage device 330 is capable of providing persistent storage for the computing system 300. The storage device 330 can be a floppy disk device, a hard disk device, an optical disk device, or a tape device, or other suitable persistent storage means. The input/output device 340 provides input/output operations for the computing system 300. In some implementations of the current subject matter, the input/output device 340 includes a keyboard and/or pointing device. In various implementations, the input/output device 340 includes a display unit for displaying graphical user interfaces.

According to some implementations of the current subject matter, the input/output device 340 can provide input/output operations for a network device. For example, the input/output device 340 can include Ethernet ports or other networking ports to communicate with one or more wired and/or wireless networks (e.g., a local area network, a wide area network, or the Internet).

In some implementations of the current subject matter, the computing system 300 can be used to execute various interactive computer software applications that can be used for organization, analysis and/or storage of data in various (e.g., tabular) format (e.g., Microsoft Excel®, and/or any other type of software). Alternatively, the computing system 300 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. The applications can include various add-in functionalities or can be standalone computing products and/or functionalities. Upon activation within the applications, the functionalities can be used to generate the user interface provided using the input/output device 340. The user interface can be generated and presented to a user by the computing system 300 (e.g., on a computer screen monitor).

One or more aspects or features of the subject matter described herein can be realized in digital electronic circuitry, integrated circuitry, specially designed application specific integrated circuit, field programmable gate arrays computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and programmable logic devices, used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube or a liquid crystal display or a light emitting diode monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

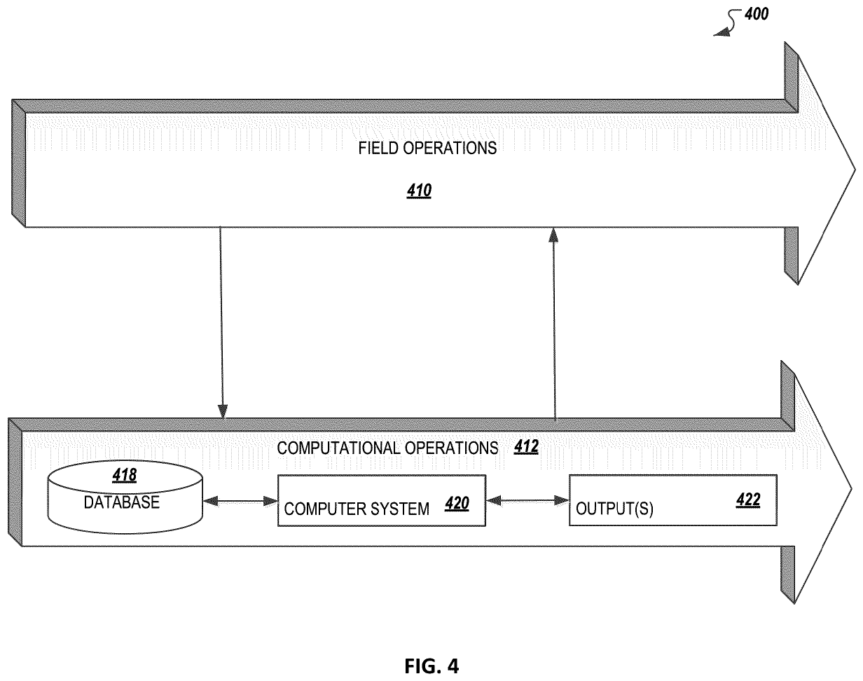

FIG. 4 illustrates hydrocarbon production operations 400 that include both one or more field operations 410 and one or more computational operations 412, which exchange information and control exploration for the production of hydrocarbons. In some implementations, outputs of techniques of the present disclosure can be performed before, during, or in combination with the hydrocarbon production operations 400, specifically, for example, either as field operations 410 or computational operations 412, or both.

Examples of field operations 410 include forming/drilling a wellbore, hydraulic fracturing, producing through the wellbore, injecting fluids (such as water) through the wellbore, to name a few. In some implementations, methods of the present disclosure can trigger or control the field operations 410. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 410 and responsively triggering the field operations 410 including, for example, generating plans and signals that provide feedback to and control physical components of the field operations 410. Alternatively or in addition, the field operations 410 can trigger the methods of the present disclosure. For example, implementing physical components (including, for example, hardware, such as sensors) deployed in the field operations 410 can generate plans and signals that can be provided as input or feedback (or both) to the methods of the present disclosure.

Examples of computational operations 412 include one or more computer systems 420 that include one or more processors and computer-readable media (e.g., non-transitory computer-readable media) operatively coupled to the one or more processors to execute computer operations to perform the methods of the present disclosure. The computational operations 412 can be implemented using one or more databases 418, which store data received from the field operations 410 and/or generated internally within the computational operations 412 (e.g., by implementing the methods of the present disclosure) or both. For example, the one or more computer systems 420 process inputs from the field operations 410 to assess conditions in the physical world, the outputs of which are stored in the databases 418. For example, seismic sensors of the field operations 410 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 412 where they are stored in the databases 418 and analyzed by the one or more computer systems 420.

In some implementations, one or more outputs 422 generated by the one or more computer systems 420 can be provided as feedback/input to the field operations 410 (either as direct input or stored in the databases 418). The field operations 410 can use the feedback/input to control physical components used to perform the field operations 410 in the real world.

For example, the computational operations 412 can process the seismic data to generate three-dimensional (3D) maps of the subsurface formation. The computational operations 412 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 412 to process new information about the formation and control the drilling to adjust to the observed conditions in real-time.

The one or more computer systems 420 can update the 3D maps of the subsurface formation as information from one exploration well is received and the computational operations 412 can adjust the location of the next exploration well based on the updated 3D maps. Similarly, the data received from production operations can be used by the computational operations 412 to control components of the production operations. For example, production well and pipeline data can be analyzed to predict slugging in pipelines leading to a refinery and the computational operations 412 can control machine operated valves upstream of the refinery to reduce the likelihood of plant disruptions that run the risk of taking the plant offline.

In some implementations of the computational operations 412, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are located in different countries or other jurisdictions.

The preceding figures and accompanying description illustrate example processes and computer implementable techniques. The environments and systems described above (or their software or other components) may contemplate using, implementing, or executing any suitable technique for performing these and other tasks. It will be understood that these processes are for illustration purposes only and that the described or similar techniques may be performed at any appropriate time, including concurrently, individually, in parallel, and/or in combination. In addition, many of the operations in these processes may take place simultaneously, concurrently, in parallel, and/or in different orders than as shown. Moreover, processes may have additional operations, fewer operations, and/or different operations, so long as the methods remain appropriate.

In other words, although the disclosure has been described in terms of certain implementations and generally associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications may be made without departing from the spirit and scope of the present disclosure. Accordingly, other implementations are within the scope of the following claims.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1. A computer-implemented method comprising: receiving, by one or more processors from probes, probe data indicative of vulnerabilities of one or more devices to cybersecurity threats, the one or more devices being connected over a network; generating, by the one or more processors, aggregated probe data by mapping the probe data using data relationships obtained from a relational database, the data relationships defining vulnerability types of cybersecurity threats; determining, by the one or more processors, a cybersecurity compliance score of each of the one or more devices using a correlation of the aggregated probe data to cybersecurity status scenarios defining consequences related to the cybersecurity threats; and providing, by the one or more processors, a cybersecurity assessment report comprising the compliance score of the one or more devices and an action plan preventing the consequences related to the cybersecurity threats.

Example 2. The computer-implemented method of example 1, wherein processing, by the one or more processors, the probe data comprises filtering the probe data using one or more probe data filters.

Example 3. The computer-implemented method of any one of the previous examples, wherein processing, by the one or more processors, the probe data comprises aggregating the probe data based on probe data types.

Example 4. The computer-implemented method of any one of the previous examples, further comprising: controlling, by the one or more processors, probe data collection using a probe data collection schedule defining a frequency of probe data collection for each of the one or more devices.

Example 5. The computer-implemented method of any one of the previous examples, wherein determining, by the one or more processors, the cybersecurity status comprises determining, by the one or more processors, an overall cybersecurity status level and comparing, by the one or more processors, the overall cybersecurity status level to target key performance indicators.

Example 6. The computer-implemented method of any one of the previous examples, further comprising: generating, by the one or more processors, the action plan comprising one or more remediation commands.

Example 7. The computer-implemented method of any one of the previous examples, further comprising: transmitting, by the one or more processors, the one or more remediation commands configured to adjust at least one configuration setting of at least one of one or more devices.

Example 8. The computer-implemented method of any one of the previous examples, further comprising: determining, by the one or more processors, consequences associated with the action plan.

Example 9. The computer-implemented method of any one of the previous examples, wherein the probes comprise any of a software prove, a hardware probe, an in-line probe, and an out of band probe.

Example 10. The computer-implemented method of any one of the previous examples, wherein the probe data comprises any of cybersecurity attributes and a change of a cybersecurity state of a respective device.

Example 11. A computer-implemented system comprising: memory storing application programming interface (API) information; and a server performing operations comprising: receiving, from probes, probe data indicative of vulnerabilities of one or more devices to cybersecurity threats, the one or more devices being connected over a network; generating aggregated probe data by mapping the probe data using data relationships obtained from a relational database, the data relationships defining vulnerability types of cybersecurity threats; determining a cybersecurity compliance score of each of the one or more devices using a correlation of the aggregated probe data to cybersecurity status scenarios defining consequences related to the cybersecurity threats; and providing a cybersecurity assessment report comprising the compliance score of the one or more devices and an action plan preventing the consequences related to the cybersecurity threats.

Example 12. The computer-implemented method of example 11, wherein processing the probe data comprises filtering the probe data using one or more probe data filters.

Example 13. The computer-implemented method of any one of the previous examples, wherein processing the probe data comprises aggregating the probe data based on probe data types.

Example 14. The computer-implemented method of any one of the previous examples, further comprising: controlling probe data collection using a probe data collection schedule defining a frequency of probe data collection for each of the one or more devices.

Example 15. The computer-implemented method of any one of the previous examples, wherein determining the cybersecurity status comprises determining an overall cybersecurity status level and comparing the overall cybersecurity status level to target key performance indicators.

Example 16. The computer-implemented method of any one of the previous examples, further comprising: generating the action plan comprising one or more remediation commands.

Example 17. The computer-implemented method of any one of the previous examples, further comprising: transmitting the one or more remediation commands configured to adjust at least one configuration setting of at least one of one or more devices.

Example 18. The computer-implemented method of any one of the previous examples, further comprising: determining consequences associated with the action plan.

Example 19. The computer-implemented method of any one of the previous examples, wherein the probes comprise any of a software prove, a hardware probe, an in-line probe, and an out of band probe and wherein the probe data comprises any of cybersecurity attributes and a change of a cybersecurity state of a respective device.

Example 20. A non-transitory computer-readable media encoded with a computer program, the computer program comprising instructions that when executed by one or more computers cause the one or more computers to perform operations comprising: receiving, from probes, probe data indicative of vulnerabilities of one or more devices to cybersecurity threats, the one or more devices being connected over a network; generating aggregated probe data by mapping the probe data using data relationships obtained from a relational database, the data relationships defining vulnerability types of cybersecurity threats; determining a cybersecurity compliance score of each of the one or more devices using a correlation of the aggregated probe data to cybersecurity status scenarios defining consequences related to the cybersecurity threats; and providing a cybersecurity assessment report comprising the compliance score of the one or more devices and an action plan preventing the consequences related to the cybersecurity threats.

What is claimed is:

1. A computer-implemented method comprising:
receiving, by one or more processors from probes, probe data indicative of vulnerabilities of one or more devices to cybersecurity threats, the one or more devices being connected over a network;
generating, by the one or more processors, aggregated probe data by mapping the probe data using data relationships obtained from a relational database, the data relationships defining vulnerability types of cybersecurity threats;
determining, by the one or more processors, a cybersecurity compliance score of each of the one or more devices using a correlation of the aggregated probe data to cybersecurity status scenarios defining consequences related to the cybersecurity threats; and
providing, by the one or more processors, a cybersecurity assessment report comprising the compliance score of the one or more devices and an action plan preventing the consequences related to the cybersecurity threats.

2. The computer-implemented method of claim 1, wherein processing, by the one or more processors, the probe data comprises filtering the probe data using one or more probe data filters.

3. The computer-implemented method of claim 1, wherein processing, by the one or more processors, the probe data comprises aggregating the probe data based on probe data types.

4. The computer-implemented method of claim 1, further comprising:
controlling, by the one or more processors, probe data collection using a probe data collection schedule defining a frequency of probe data collection for each of the one or more devices.

5. The computer-implemented method of claim 1, wherein determining, by the one or more processors, the cybersecurity status comprises determining, by the one or more processors, an overall cybersecurity status level and comparing, by the one or more processors, the overall cybersecurity status level to target key performance indicators.

6. The computer-implemented method of claim 1, further comprising:
generating, by the one or more processors, the action plan comprising one or more remediation commands.

7. The computer-implemented method of claim 6, further comprising:
transmitting, by the one or more processors, the one or more remediation commands configured to adjust at least one configuration setting of at least one of one or more devices.

8. The computer-implemented method of claim 6, further comprising:
determining, by the one or more processors, consequences associated with the action plan.

9. The computer-implemented method of claim 1, wherein the probes comprise any of a software prove, a hardware probe, an in-line probe, and an out of band probe.

10. The computer-implemented method of claim 1, wherein the probe data comprises any of cybersecurity attributes and a change of a cybersecurity state of a respective device.

11. A computer-implemented system comprising:
memory storing application programming interface (API) information; and
a server performing operations comprising:
receiving, from probes, probe data indicative of vulnerabilities of one or more devices to cybersecurity threats, the one or more devices being connected over a network;
generating aggregated probe data by mapping the probe data using data relationships obtained from a relational database, the data relationships defining vulnerability types of cybersecurity threats;
determining a cybersecurity compliance score of each of the one or more devices using a correlation of the aggregated probe data to cybersecurity status scenarios defining consequences related to the cybersecurity threats; and
providing a cybersecurity assessment report comprising the compliance score of the one or more devices and an action plan preventing the consequences related to the cybersecurity threats.

12. The computer-implemented method of claim 11, wherein processing the probe data comprises filtering the probe data using one or more probe data filters.

13. The computer-implemented method of claim 11, wherein processing the probe data comprises aggregating the probe data based on probe data types.

14. The computer-implemented method of claim 11, further comprising:
controlling probe data collection using a probe data collection schedule defining a frequency of probe data collection for each of the one or more devices.

15. The computer-implemented method of claim 11, wherein determining the cybersecurity status comprises determining an overall cybersecurity status level and comparing the overall cybersecurity status level to target key performance indicators.

16. The computer-implemented method of claim 11, further comprising:
generating the action plan comprising one or more remediation commands.

17. The computer-implemented method of claim 16, further comprising:
transmitting the one or more remediation commands configured to adjust at least one configuration setting of at least one of one or more devices.

18. The computer-implemented method of claim 16, further comprising:
determining consequences associated with the action plan.

19. The computer-implemented method of claim 11, wherein the probes comprise any of a software prove, a hardware probe, an in-line probe, and an out of band probe and wherein the probe data comprises any of cybersecurity attributes and a change of a cybersecurity state of a respective device.

20. A non-transitory computer-readable media encoded with a computer program, the computer program comprising instructions that when executed by one or more computers cause the one or more computers to perform operations comprising:
receiving, from probes, probe data indicative of vulnerabilities of one or more devices to cybersecurity threats, the one or more devices being connected over a network;
generating aggregated probe data by mapping the probe data using data relationships obtained from a relational database, the data relationships defining vulnerability types of cybersecurity threats;
determining a cybersecurity compliance score of each of the one or more devices using a correlation of the aggregated probe data to cybersecurity status scenarios defining consequences related to the cybersecurity threats; and
providing a cybersecurity assessment report comprising the compliance score of the one or more devices and an action plan preventing the consequences related to the cybersecurity threats.
